(19) United States
(12) Patent Application Publication
(10) Pub. No.: US 2026/0159639 A1
(43) Pub. Date: Jun. 11, 2026

(54) Compositions Comprising Cleavable Crosslinkers

(71) Applicant: 3M INNOVATIVE PROPERTIES COMPANY, St. Paul, MN (US)

(72) Inventors: Kelly A. Volp, Minneapolis, MN (US); Ken Kawamoto, St. Paul, MN (US); Peter O. Rekow, Woodbury, MN (US); Clinton J. Cook, Woodbury, MN (US); Kathleen S. Shafer, Woodbury, MN (US); Jason D. Clapper, Lino Lakes, MN (US)

(21) Appl. No.: 18/706,244

(22) PCT Filed: Nov. 15, 2022
(86) PCT No.: PCT/IB2022/060999

§ 371 Date: Apr. 30, 2024

Related U.S. Application Data
(60) Provisional application No. 63/290,137, filed on Dec. 16, 2021.

(51) Int. Cl. C08G 59/42

(52) U.S. Cl. CPC C08G 59/423

(57) ABSTRACT

Compositions, such as adhesive compositions, are described comprising a cleavable crosslinker. The composition further comprise an epoxy resin and/or at least one other free-radically polymerizable monomer, oligomer, polymer, or combination thereof. Also described are adhesive articles and methods of bonding.

### SUMMARY

In one embodiment, a composition is described comprising: a) an epoxy resin; and b) a cleavable crosslinker comprising at least two free-radically polymerizable groups. In some embodiments, the composition further comprises at least one other free-radically polymerizable monomer, oligomer, polymer, or combination thereof. In one embodiment, the other free-radically polymerizable component comprises a (meth)acrylic polymer, a non-cleavable crosslinker, or a combination thereof. The composition may further comprise a hydroxy-containing component, such as a polyol.

The cleavable crosslinker typically comprises a group having the formula —O—X(R2)(R3)-O—, wherein X is C or Si and R1 and R2 are independently hydrogen, alkyl, aryl; or X is C and together with R2 and R3 is a cycloaliphatic group. Representative cleavable crosslinkers may have the formula:

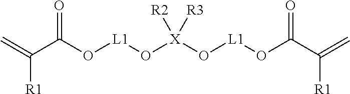

wherein X is C or Si;
R1 is independently hydrogen or methyl;
L1 is independently a divalent linking group; and
R2 and R3 are independently hydrogen, alkyl, aryl, or X is C and together with R2 and R3 is a cycloaliphatic group.

Also described is a cleavable crosslinker of such formula wherein X is C and together with R2 and R3 is a cycloaliphatic group. Also described is a composition comprising such cleavable crosslinker; and at least one other free-radically polymerizable monomer, oligomer, polymer or combination thereof.

The compositions typically further comprise a free radical initiator and an acid component such as a photoacid generator or thermal acid generation. Such components are included when the composition is made or added prior to use.

In other embodiments, compositions are described wherein the free-radically polymerizable component is polymerized and the composition comprises crosslinks of uncleaved cleavable crosslinker, cleaved cleavable crosslinker fragments, or a combination thereof.

Also described are polymeric films (e.g. of an adhesive-coated article such as a tape or film) comprising the free-radically polymerized product of the composition described herein. In one embodiment, the composition further comprises uncured epoxy resin moieties and crosslinks of uncleaved cleavable crosslinker. In some embodiments, the polymeric film exhibits a storage modulus (G′) of greater than 8 kPa at 25° C. and 1 hertz. In another embodiment, the composition further comprises uncured epoxy resin moieties and cleaved cleavable crosslinker fragments. In some embodiments, the polymeric film has a greater tan(delta) and/or lower storage modulus (G′) than the same polymeric film with uncleaved cleavable crosslinker. In some embodiments, upon curing of the epoxy resin, the polymeric film exhibits a G′ at least 5 times greater than the same polymeric film with uncured epoxy resin.

Also described is an adhesive article comprising a substrate and the polymeric film described herein. The substrate may be a release liner or the polymeric film may be permanently bonded to a (e.g. tape backing) substrate.

Also described is a method of bonding comprising utilizing the composition or polymeric film of the previous claims to bond a first substrate to a second substrate.

Also, an adhesive bonded article is described comprising a first and second substrate bonded with the composition or polymeric film described herein.

### DETAILED DESCRIPTION

### Cleavable Crosslinker

Cleavable crosslinkers, also referred to as degradable crosslinkers, are generally crosslinkers that are capable of copolymerizing with other free-radically polymerizable monomers to form a crosslinked polymeric network. Unlike conventional crosslinkers, cleavable crosslinkers are also capable of cleaving into separate fragments at the location of a covalent bond. In some embodiments, such cleavage, also described herein as activation, is generally achieved by exposing the crosslinked composition to an energy source such as heat and/or (e.g. ultraviolet) actinic radiation.

In some embodiments, the composition described herein comprise polymerized units derived from a cleavable crosslinking monomer comprising at least two free-radically polymerizable groups and at least one group having the formula —O—X(R₂)(R₃)—O—, wherein X is carbon or silicon, and R₂ and R₃ are independently hydrogen, (e.g. C₁-C₆) alkyl, and aryl. In some embodiments, X is carbon and X together with R₂ and R₃ form a cycloaliphatic (e.g. C6) group. The alkyl and aryl groups may optionally comprise substituents. The alkyl group may be linear or branched such as in the case of methyl, ethyl, propyl, butyl, or hexyl. In some embodiments, at least one of or both of R₂ and R₃ are independently hydrogen or methyl.

The free-radically polymerizable groups are generally copolymerized with other free-radically polymerizable monomer, oligomers, or polymers thereby incorporating polymerized units derived from the cleavable monomer into the backbone of the (meth)acrylic polymer. The free-radically polymerizable groups are ethylenically unsaturated terminal polymerizable groups including (meth)acryl such as (meth)acrylamide (H₂C═CHCON— and H₂C═CH(CH₃)CON—) and (meth)acrylate(CH₂CHCOO— and CH₂C(CH₃)COO—). When at least 50 wt. % of the free-radically polymerizable groups are (meth)acrylate groups, the polymer may be characterized as a (meth)acrylic polymer. Other ethylenically unsaturated polymerizable groups include vinyl (H₂C═C—) including vinyl ethers (H₂C═CHOCH—).

In some embodiments, the cleavable crosslinking monomer typically has the formula:

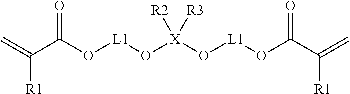

wherein
R₁ is hydrogen or methyl;
X is C or Si;
R2 and R3 are independently hydrogen, (e.g. C1-C6) alkyl, aryl, or X together with R2 and R3 form a (e.g. C6) cycloaliphatic group; and
L₁ is independently a divalent linking group.

The alkyl and aryl group may optionally comprise substituents. The divalent linking group, L₁, typically has a molecular weight no greater than 500, 250, 100, 75 or 50 g/mole. In some embodiments, the divalent linking group, L₁, is a (e.g. C1-C10) alkylene group. In some embodiments, L₁ is a C₂ or C₃ alkylene group. In other embodiments, L₁ is an alkylene group having at least 4 carbon atoms. In this embodiments, L₁ is an alkylene group having 4, 5, 6, 7, 8, 9, or 10 carbon atoms as well as any range of carbon atoms defined by such integers.

In some embodiments, the cleavable crosslinking monomer has two —O—C(R₂)(R₃)—O— groups. In such embodiment, the cleavable crosslinking monomer may have the formula:

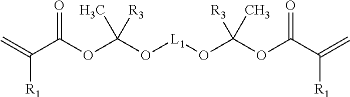

wherein R₁=R1, R₃=R3 and L₁=L1, as previously described.

The cleavable group may be characterized as an acetal or ketal group. Representative cleavable crosslinking monomers include for example 2,2-di(2-acryloxyethoxy)propane); (butane-1,4-diylbis(oxy))bis(ethane-1,1-diyl) diacrylate); bis(2-hydroxethyl methacrylate) acetal; bis(2-hydroxyethyl acrylate) acetal; acetone bis(2-hydroxypropyl methacrylate) ketal; and acetone bis (2-hydroxypropyl acrylate) ketal.

In some embodiments, X is Si and R2 and R3 are methyl.

In some embodiments, X is C and X together with R2 and R3 form a cycloaliphatic ring. The number of carbon atoms of the cycloaliphatic ring is typically 5, 6, 7, or 8 as well as any range of carbon atoms defined by such integers.

Representative cleavable crosslinkers include the following:

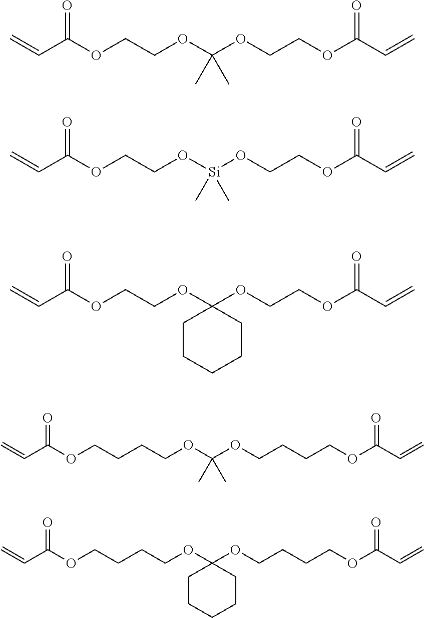

Cleavable crosslinkers wherein X is C are described for example in U.S. Pat. Nos. 9,732,173 and 5,872,158. Cleavable crosslinkers wherein X is Si or X is C and together with R₂ and R₃ form a cycloaliphatic group are described in the forthcoming examples.

The composition comprises cleavable crosslinking monomer in an amount of at least 0.05, 0.1, 0.2 wt. % and can generally range up to 50 wt. % of the (e.g. unfilled) composition. In typical embodiments the concentration of cleavable crosslinking monomer is at least 0.5 or 1 or 2 or 3 or 4 or 5 wt. % of the composition. In some embodiments, the concentration of cleavable crosslinking monomer is typically no greater than 25, 20, 15 or 10 wt. % of the (e.g. unfilled) composition. The composition may comprise a single cleavable crosslinking monomer or a combination of two or more of such able crosslinking monomers. When the composition comprises a combination of cleavable crosslinking monomers, the total concentration generally falls within the ranges just described.

In some embodiments, the composition further comprises a non-cleavable crosslinkers such as a multifunctional (meth)acrylate crosslinking monomer. Examples of useful multifunctional (meth)acrylate include, but are not limited to, di(meth)acrylates, tri(meth)acrylates, and tetra(meth)acrylates, such as 1,6-hexanediol di(meth)acrylate, poly(ethylene glycol) di(meth)acrylates, polybutadiene di(meth)acrylate, polyurethane di(meth)acrylates, and propoxylated glycerin tri(meth)acrylate, and mixtures thereof.

Other non-cleavable crosslinkers, such as chlorinated triazine crosslinking compounds, are known in the art.

When utilized, non-cleavable crosslinker(s) are typically present in an amount of at least 0.05, 0.1, 0.2, 0.3, 0.4, 0.5, 0.6, 0.7, 0.8, 0.9, or 1 wt. % of the (e.g. unfilled) composition. In some embodiments, the amount of non-cleavable crosslinker(s) is no greater than 15, 10, or 5 wt. % of the unfilled composition.

In some embodiments, the composition may be characterized as an adhesive.

### Epoxy Resin

In some embodiments, the composition comprises a known or novel cleavable crosslinker and one or more epoxy resins. The epoxy resins or epoxides that are useful in the composition of the present disclosure may be any organic compound having at least one oxirane ring that is polymerizable by ring opening, i.e., an average epoxy functionality greater than one, and preferably at least two. The epoxides can be monomeric or polymeric, and aliphatic, cycloaliphatic, heterocyclic, aromatic, hydrogenated, or mixtures thereof. Preferred epoxides contain more than 1.5 epoxy group per molecule and preferably at least 2 epoxy groups per molecule. The useful materials typically have a weight average molecular weight of about 150 to about 10,000, and more typically of about 180 to about 1,000. The molecular weight of the epoxy resin is usually selected to provide the desired properties of the cured composition. Suitable epoxy resins include linear polymeric epoxides having terminal epoxy groups (e.g., a diglycidyl ether of a polyoxyalkylene glycol), polymeric epoxides having skeletal epoxy groups (e.g., polybutadiene poly epoxy), and polymeric epoxides having pendent epoxy groups (e.g., a glycidyl methacrylate polymer or copolymer), and mixtures thereof. The epoxide-containing materials include compounds having the general formula:

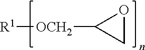

where R1 is an alkyl, alkyl ether, or aryl, and n is 1 to 6.

These epoxy resins include aromatic glycidyl ethers, e.g., such as those prepared by reacting a polyhydric phenol with an excess of epichlorohydrin, cycloaliphatic glycidyl ethers, hydrogenated glycidyl ethers, and mixtures thereof. Such polyhydric phenols may include resorcinol, catechol, hydroquinone, and the polynuclear phenols such as p,p′-dihydroxydibenzyl, p,p′-dihydroxydiphenyl, p,p′-dihydroxyphenyl sulfone, p,p′-dihydroxybenzophenone, 2,2′-dihydroxy-1, 1-dinaphthylmethane, and the 2,2′, 2,3′, 2,4′, 3,3′, 3,4′, and 4,4′ isomers of dihydroxydiphenylmethane, dihydroxydiphenyldimethylmethane, dihydroxydiphenylethylmethylmethane, dihydroxydiphenylmethylpropylmethane, dihydroxydiphenylethylphenylmethane, dihydroxydiphenylpropylphenylmethane, dihydroxydiphenylbutylphenylmethane, dihydroxydiphenyltolylethane, dihydroxydiphenyltolylmethylmethane, dihydroxydiphenyldicyclohexylmethane, and dihydroxydiphenylcyclohexane.

Also useful are polyhydric phenolic formaldehyde condensation products as well as polyglycidyl ethers that contain as reactive groups only epoxy groups or hydroxy groups. Useful curable epoxy resins are also described in various publications including, for example, “Handbook of Epoxy Resins” by Lee and Nevill, McGraw-Hill Book Co., New York (1967), and Encyclopedia of Polymer Science and Technology, 6, p. 322 (1986).

The choice of the epoxy resin used depends upon the end use for which it is intended. Epoxides with flexibilized backbones may be desired where a greater amount of ductility is needed in the bond line. In some embodiments, the composition is suitable for use as a structural adhesive. Materials such as diglycidyl ethers of bisphenol A and diglycidyl ethers of bisphenol F can provide desirable structural adhesive properties that these materials attain upon curing, while hydrogenated versions of these epoxies may be useful for compatibility with substrates having oily surfaces.

Examples of commercially available epoxides useful in the present disclosure include diglycidyl ethers of bisphenol A (e.g, those available under the trade designations EPON 828, EPON 1001, EPON 1004, EPON 2004, EPON 1510, and EPON 1310 from Momentive Specialty Chemicals, Inc., and those under the trade designations D.E.R. 331, D.E.R. 332, D.E.R. 334, and D.E.N. 439 available from Dow Chemical Co.); diglycidyl ethers of bisphenol F (e.g., that are available under the trade designation ARALDITE GY 281 available from Huntsman Corporation); silicone resins containing diglycidyl epoxy functionality; flame retardant epoxy resins (e.g., that are available under the trade designation DER 560, a brominated bisphenol type epoxy resin available from Dow Chemical Co.); and 1,4-butanediol diglycidyl ethers.

Epoxy-containing compounds having at least one glycidyl ether terminal portion, and preferably, a saturated or unsaturated cyclic backbone may optionally be added to the composition as reactive diluents. Reactive diluents may be added for various purposes such as to aid in processing, e.g., to control the viscosity in the composition as well as during curing, to flexibilize the cured composition, and to compatibilize materials in the composition.

Examples of such diluents include: diglycidyl ether of cyclohexanedimethanol, diglycidyl ether of resorcinol, p-tert-butyl phenyl glycidyl ether, cresyl glycidyl ether, diglycidyl ether of neopentyl glycol, triglycidyl ether of trimethylolethane, triglycidyl ether of trimethylolpropane, triglycidyl p-amino phenol, N,N′-diglycidylaniline, N,N,N′N′-tetraglycidyl meta-xylylene diamine, and vegetable oil polyglycidyl ether. Reactive diluents are commercially available under the trade designation HELOXY 107 and CARDURA N10 from Momentive Specialty Chemicals, Inc. The composition may contain a toughening agent to aid in providing the desired overlap shear, peel resistance, and impact strength.

The (e.g. adhesive) composition desirably contains one or more epoxy resins having an epoxy equivalent weight of at least 100, 200 or 300 and typically no greater than 1500, 1200, or 1000. In some embodiments, the adhesive contains two or more epoxy resins, wherein at least one epoxy resin has an epoxy equivalent weight of from about 300 to about 500, and at least one epoxy resin has an epoxy equivalent weight of from about 1000 to about 1200.

In some embodiments, the (e.g. structural) adhesive composition comprises one or more epoxy resins in an amount of at least 20, 25 or 30 wt. % and typically no greater than 95, 90, 85, 80, 75, or 70 wt. % of the unfilled (e.g. adhesive) composition or in other words the total amount of organic components except for organic polymeric fillers.

### (Meth)Acrylic Polymer

In some embodiments, the (e.g. adhesive) composition comprises a (meth)acrylic polymer. In some embodiments, the (meth)acrylic polymer may be characterized as a film-forming polymer.

In one embodiment, the (e.g. adhesive) composition comprises known or novel cleavable crosslinkers, an epoxy resin, as previously described, and a (meth)acrylic polymer

In another embodiment, the novel cleavable crosslinkers (i.e. wherein X together with R2 and R3 form a cycloaliphatic group) can be combined with a (meth)acrylic polymer, in the absence of an epoxy resin. The novel cleavable crosslinkers can be utilized in place of known cleavable crosslinkers in adhesive compositions, as described in U.S. Pat. No. 9,732,173; incorporated herein by reference.

In some embodiments, the polymer is a (meth)acrylic polymer comprises polymerized units of one or more (meth)acrylate ester monomers derived from a (e.g. non-tertiary) alcohol containing from 1 to 14 carbon atoms and preferably an average of from 4 to 12 carbon atoms. The (meth)acrylic polymer may also comprise one or more other monomers common to acrylic polymers and adhesives such as acid-functional ethylenically unsaturated monomers, non-acid-functional polar monomers, and vinyl monomers.

Examples of monomers include the esters of either acrylic acid or methacrylic acid with non-tertiary alcohols such as ethanol, 1-propanol, 2-propanol, 1-butanol, 2-butanol, 1-pentanol, 2-pentanol, 3-pentanol, 2-methyl-1-butanol, 3-methyl-1-butanol, 1-hexanol, 2-hexanol, 2-methyl-1-pentanol, 3-methyl-1-pentanol, 2-ethyl-1-butanol, 3,5,5-trimethyl-1-hexanol, 3-heptanol, 1-octanol, 2-octanol, isoctylalcohol, 2-ethyl-1-hexanol, 1-decanol, 2-propyl-heptanol, 1-dodecanol, 1-tridecanol, 1-tetradecanol, and the like.

In some embodiments, the (meth)acrylic polymer comprises one or more low Tg monomers, having a Tg no greater than 10° C. when the monomer is polymerized (i.e. independently) to form a homopolymer. In some embodiments, the low Tg monomers have a Tg no greater than 0° C., no greater than −5° C., or no greater than −10° C. when reacted to form a homopolymer. The Tg of these homopolymers is often greater than or equal to −80° C., greater than or equal to −70° C., greater than or equal to −60° C., or greater than or equal to −50° C. The Tg of these homopolymers can be, for example, in the range of −80° C. to 20° C., −70° C. to 10° C., −60° C. to 0° C., or −60° C. to −10° C.

The low Tg monomer may have the formula

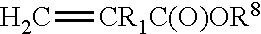

wherein R₁ is H or methyl and R⁸ is an alkyl with 1 to 22 carbons or a heteroalkyl with 2 to 20 carbons and 1 to 6 heteroatoms selected from oxygen or sulfur. The alkyl or heteroalkyl group can be linear, branched, cyclic, or a combination thereof.

Low Tg monomers include for example ethyl acrylate, n-propyl acrylate, n-butyl acrylate, isobutyl acrylate, t-butyl acrylate, n-pentyl acrylate, isoamyl acrylate, n-hexyl acrylate, 2-methylbutyl acrylate, 2-ethylhexyl acrylate, 4-methyl-2-pentyl acrylate, n-octyl acrylate, 2-octyl acrylate, isooctyl acrylate, isononyl acrylate, decyl acrylate, isodecyl acrylate, lauryl acrylate, isotridecyl acrylate, octadecyl acrylate, and dodecyl acrylate.

Low Tg heteroalkyl acrylate monomers include, for example, 2-methoxyethyl acrylate and 2-ethoxyethyl acrylate.

In some embodiments, (meth)acrylic polymer comprises at least one low Tg monomer having a non-cyclic alkyl (meth)acrylate monomer(s) having 4 to 20 carbon atoms. In some embodiments, the (meth)acrylic polymer and/or pressure-sensitive adhesive (PSA) comprises at least one low Tg monomer having a (e.g. branched) alkyl group with 6 to 20 carbon atoms. In some embodiments, the low Tg monomer has a (e.g. branched) alkyl group with 7 or 8 carbon atoms. Exemplary monomers include, but are not limited to, 2-ethylhexyl (meth)acrylate, isooctyl (meth)acrylate, n-octyl (meth)acrylate, 2-octyl (meth)acrylate, isodecyl (meth)acrylate, and lauryl (meth)acrylate.

In some embodiments, the (e.g. low Tg) monomer is the ester of (meth)acrylic acid with an alcohol derived from a renewable source. A suitable technique for determining whether a material is derived from a renewable resource is through ¹⁴C analysis according to ASTM D6866-10, as described in US2012/0288692. The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modem reference standard. The ratio is reported as a percentage with the units “pMC” (percent modem carbon).

One suitable monomer derived from a renewable source is 2-octyl (meth)acrylate, as can be prepared by conventional techniques from 2-octanol and (meth)acryloyl derivatives such as esters, acids and acyl halides. The 2-octanol may be prepared by treatment of ricinoleic acid, derived from castor oil, (or ester or acyl halide thereof) with sodium hydroxide, followed by distillation from the co-product sebacic acid. Other (meth)acrylate ester monomers that can be renewable are those derived from ethanol, 2-methyl butanol and dihydrocitronellol.

In some embodiments, the (meth)acrylic polymer comprises a bio-based content of at least 25, 30, 35, 40, 45, or 50 wt. % using ASTM D6866-10, method B. In other embodiments, the (e.g. pressure sensitive) adhesive composition comprises a bio-based content of at least 55, 60, 65, 70, 75, or 80 wt. %. In yet other embodiments, the composition comprises a bio-based content of at least 85, 90, 95, 96, 97, 99 or 99 wt. %.

In some embodiments, the (meth)acrylic polymer comprises a high Tg monomer, having a Tg greater than 10° C. and typically of at least 15° C., 20° C. or 25° C., and preferably at least 50° C. Suitable high Tg alkyl (meth)acrylate monomers include, for example, t-butyl acrylate, methyl methacrylate, ethyl methacrylate, isopropyl methacrylate, n-butyl methacrylate, isobutyl methacrylate, s-butyl methacrylate, t-butyl methacrylate, stearyl methacrylate, phenyl methacrylate, cyclohexyl methacrylate, t-butyl cyclohexyl acrylate, isobornyl acrylate, isobornyl methacrylate (110° C., according to Aldrich), norbornyl (meth)acrylate, benzyl methacrylate, 3,3,5-trimethylcyclohexyl acrylate, cyclohexyl acrylate, N-octyl acrylamide, and propyl methacrylate or combinations.

The alkyl (meth)acrylate monomers are typically present in the (meth)acrylic polymer in an amount of at least 50, 55, 60, 65, or 75 wt. % of the composition.

In some embodiments, the (meth)acrylic polymer composition comprises at least 50, 55, 60, 65, 70, 75, 80, 85, 90 or 95 wt. % or greater of low Tg ethylenically unsaturated monomer(s). In this embodiment, the (meth)acrylic polymer composition may be characterized as a pressure sensitive adhesive. When high Tg ethylenically unsaturated monomers are included in a pressure sensitive adhesive, the adhesive may include at least 5, 10, 15, 20, to 30 wt. % of high Tg monomer(s).

In other embodiments, the (meth)acrylic polymer composition comprises at least 50, 55, 60, 65, 70, 75, 80, 85, 90 or 95 wt. % or greater of high Tg ethylenically unsaturated monomer(s). In this embodiment, the (meth)acrylic polymer composition may be characterized as a semi-structural or structural adhesive. Semi-structural or structural adhesives may exhibit PSA properties when initially bonded, but cure to a sufficiently high modulus such that the adhesive is not a PSA after curing. When low Tg ethylenically unsaturated monomers are included in a pressure sensitive adhesive, the adhesive may include at least 5, 10, 15, 20, to 30 wt. % of low Tg monomer(s).

The (meth)acrylic polymer may optionally comprise polymerized units of an acid-functional monomer. Useful acid-functional monomers include, but are not limited to, those selected from ethylenically unsaturated carboxylic acids, ethylenically unsaturated sulfonic acids, ethylenically unsaturated phosphonic acids, and mixtures thereof. Examples of such compounds include those selected from acrylic acid, methacrylic acid, itaconic acid, fumaric acid, crotonic acid, citraconic acid, maleic acid, oleic acid, b-carboxyethyl (meth)acrylate, 2-sulfoethyl methacrylate, styrene sulfonic acid, 2-acrylamido-2-methylpropanesulfonic acid, vinylphosphonic acid, and mixtures thereof. In some embodiments, the (meth)acrylic polymer comprises at least 0.5, 1, 2, 3, 4, 5, 6, 7, 8, 9, or 10 wt. % of polymerized units of acid-functional monomer(s). The amount of acid-functional monomer(s) is typically no greater than 15, 14, 13, 12, 11, or 10 wt. %. In other embodiments, the (meth)acrylic polymer comprises little (i.e. less than 0.5 wt. %) or no acid-functional monomer(s).

The (meth)acrylic polymer may optionally comprise polymerized units of non-acid-functional polar monomer. Representative examples include but are not limited to 2-hydroxyethyl (meth)acrylate; N-vinylpyrrolidone; N-vinylcaprolactam; acrylamide; mono- or di-N-alkyl substituted acrylamide; t-butyl acrylamide; dimethylaminoethyl acrylamide; N-octyl acrylamide; poly(alkoxyalkyl) (meth)acrylates including 2-(2-ethoxyethoxy)ethyl (meth)acrylate (E3A), 2-ethoxyethyl (meth)acrylate, 2-methoxyethoxyethyl (meth)acrylate, 2-methoxyethyl methacrylate, polyethylene glycol mono(meth)acrylates; alkyl vinyl ethers, including vinyl methyl ether; and mixtures thereof. Preferred polar monomers include those selected from the group consisting of 2-hydroxyethyl (meth)acrylate and N-vinylpyrrolidinone. In some embodiments, the (meth)acrylic polymer comprises at least 0.5, 1, 2, 3, 4, 5, 6, 7, 8, 9, or 10 wt. % of polymerized units of non-acid-functional polar monomer(s). The amount of such polar monomer(s) is typically no greater than 20, 15, or 10 wt. %. In other embodiments, the (meth)acrylic polymer comprises little (i.e. less than 0.5 wt. %) or no non-acid functional polar monomer(s).

The (meth)acrylic polymer may optionally comprise polymerized units of vinyl monomer. Representative examples include but are not limited to vinyl esters (e.g., vinyl acetate and vinyl propionate), styrene, substituted styrene (e.g., a-methyl styrene), vinyl halide, and mixtures thereof. When present, the (meth)acrylic polymer typically comprises at least 0.5, 1, 2, 3, 4, or 5 wt. % of vinyl monomer(s). In other embodiments, the (meth)acrylic polymer comprises little (i.e. less than 0.5 wt. %) or no vinyl monomer(s).

In one embodiment, the (meth)acrylic polymer is a copolymer of tetrahydrofurfuryl (meth)acrylate and a C₁-C₈ alkyl (meth)acrylate ester monomer; as described in U.S. Pat. No. 10,676,655; incorporated herein by reference. Useful monomers include the acrylates and methacrylates of methyl, ethyl, propyl, isopropyl, butyl, pentyl, hexyl, heptyl and octyl alcohols, including all isomers, and mixtures thereof. In some embodiments, the alcohol is selected from C₃-C₆ alkanols.

In some embodiments, at least two C₁-C₈ alkyl (meth)acrylate ester monomers are utilized wherein in one is a low Tg monomer such as butyl acrylate or octyl acrylate and one is a higher Tg cyclic alkyl (meth)acrylate ester monomer, such as isobornyl acrylate or t-butyl cyclohexyl acrylate.

In one embodiment, the (meth)acrylic polymer may comprise polymerized units of:
a) 10-60 wt. % oftetrahydrofurfuryl (meth)acrylate
b) 40-85 wt. % of C₁-C₈ alkyl (meth)acrylate ester monomers;
c) 0 to 50 wt. % of cationically reactive functional monomers;
wherein the sum of a)-c) is 100 wt. %.

The copolymer may contain polymerized units of a cationically reactive monomer, such as glycidyl acrylate, glycidyl methacrylate, hydroxyethyl acrylate, hydroxyethyl methacrylate, hydroxypropyl methylacrylate, hydroxybutyl acrylate, hydroxypropyl acrylate, and alkoxysilylalkyl (meth)acrylates, such as trimethoxysilylpropyl acrylate.

In some embodiments, the amount of c) is at least 5, 10, 15, or 20 wt. % of the (meth)acrylic polymer. In some embodiments, the amount of c) is no greater than 45, 40, 35, 30, 25 or 20 wt. % of the (meth)acrylic polymer. In other embodiments, the (meth)acrylic polymer is a homopolymer or copolymer of the cleavable crosslinker. Such homopolymer or copolymer can be combined with an epoxy resin as depicted by Examples 23-24.

When the polymer is combined with an epoxy resin, it typically does not contain any acrylic monomers having moieties sufficiently basic so as to inhibit cationic cure of the adhesive composition.

### Optional Hydroxyl-Functional Components

In some embodiments, the epoxy-resin-containing (e.g. adhesive) composition further comprises a low molecular weight, liquid (at 25° C.) hydroxy-functional polyol.

Examples include polyalkylene oxide polyols such as polyoxyethylene and polyoxypropylene glycols; polyoxyethylene and polyoxypropylene triols and polytetramethylene oxide glycols. Such polyols can be suitable for retarding the curing reaction so that the “open time” of the adhesive composition can be increased.

Commercially available hydroxy-functional poly(alkylenoxy) compounds suitable for use in the present invention include, but are not limited to, the POLYMEG™ series of polytetramethylene oxide glycols (available from Lyondellbasell, Inc., Jackson, Tenn.), the TERATHANE™ series of polytetramethylene oxide glycols (from Invista, Newark, Del.); the POLYTHF™ series ofpolytetramethylene oxide glycol from BASF Corp. (Charlotte, N.C.); the ARCOL™ series of polyoxypropylene polyols (from Bayer MaterialScience., Los Angeles, Calif.) and the VORANOL™ series of polyether polyols from Dow Automotive Systems, Auburn Hills, MI.

In some embodiments, the (e.g. adhesive) composition comprises at least 5 or 10 wt. % and no greater than 30, 25 or 20 wt. % of lower M_{w}, liquid (at 25° C.) hydroxy-functional polyol(s).

### Additives

The adhesive composition may further comprise up to about 50 parts by weight (relative to 100 parts by weight of a) to d)), desirably up to about 10 percent, of various additives such as fillers, stabilizers, plasticizers, tackifiers, flow control agents, cure rate retarders, adhesion promoters (for example, silanes and titanates), adjuvants, impact modifiers, and the like, such as silica, glass, clay, talc, pigments, colorants, glass beads or bubbles, and antioxidants, so as to reduce the weight and/or cost of the structural adhesive layer composition, adjust viscosity, and/or provide additional reinforcement of the adhesive compositions and articles so that a more rapid or uniform cure may be achieved. In some embodiments, the additives do not reduce the (e.g. visible) light transmission of the adhesive layer.

### Method of Making

In some embodiments, the (e.g. adhesive) composition may be prepared by combining the cleavable crosslinker with the epoxy resin and/or (meth)acrylic polymer, and optional components. Free radical initiators (e.g. thermal initiators and/or photoinitiators) and acidic components such as photoacid generators and/or thermal acid generators are added to the composition at the time of preparing the (e.g. adhesive) composition or at the time of use of the (e,g, adhesive) composition.

In some embodiments, the (meth)acrylic polymer is separately prepared by free radical polymerization of the monomer mixture with a photo- or thermal initiator. The (meth)acrylic polymer may be prepared by any conventional free-radical polymerization method, including solution, radiation, bulk, dispersion, emulsion, solventless, and suspension processes. The resulting adhesive copolymers may be random or block (co)polymers.

In one embodiment, an epoxy resin and cleavable crosslinker are combined with a (meth)acrylic polymer (e.g. syrup).

Activation of the Cleavable Crosslinker with Acid Component

The cleavable crosslinker can be activated or in other words cleaved prior to applying the adhesive composition to a substrate, concurrent with applying the adhesive composition to a substrate, or after applying the adhesive composition to a substrate, or a combination thereof.

In some embodiments, the activation of the cleavable crosslinker is achieved by heating the composition, e.g. to a temperature ranging from 85° C. to 150° C. for durations of time ranging from 5 to 10 minutes to 30 minutes. In the absence of a thermal acid generator, higher temperatures and/or longer heating times are typically utilized.

In other embodiments, the activation of the cleavable crosslinker is achieved by the addition of acid or a photoacid generator and exposing the composition to (e.g. ultraviolet) actinic radiation. When the polymer is cured by exposure to actinic radiation, the exposure conditions that cause cleavage are generally at a different and lower wavelength bandwidth than those utilized for polymerization of the (meth)acrylic polymer. The difference is typically at least about 25 nm.

Acids that can be used to initiate this type of fragmentation include, for example, sulfuric acid, p-toluene sulfonic acid, oxalic acid, and mixtures thereof.

In favored embodiments, activation of the cleavable crosslinker is catalyzed by an acid, photoacid generator (“PAG”), or thermal acid generator (“TAG”). Thus, inclusion of such can reduce the exposure time to actinic radiation, or reduce the time and temperature of heat-activated cleavage of the crosslinking monomer. When present, the acid, photoacid or thermal acid generator is typically used in amounts of at least 0.005, 0.01, 0.1, or 1 wt. % and typically no greater than 10 wt. % of the (e.g. unfilled) composition. In some embodiments, the concentration is no greater than 5, 4, 3, 2, 1, or 0.5 wt. % of the composition.

Upon irradiation with light energy, ionic photoacid generators undergo a fragmentation reaction and release one or more molecules of Lewis or Brönsted acid that catalyze the cleavage of the cleavable crosslinking monomer. Useful photoacid generators are thermally stable and do not undergo thermally induced reactions with the copolymer, and are readily dissolved or dispersed in the composition. Preferred photoacid generators are those in which the incipient acid has a pKa value of £0. Photoacid generators are known and reference may be made to K. Dietliker, Chemistry and Technology of UV and EB Formulation for Coatings, Inks and Paints, vol. III, SITA Technology Ltd., London, 1991. Further reference may be made to Kirk-Othmer Encyclopedia of Chemical Technology, 4^{th} Edition, Supplement Volume, John Wiley and Sons, New York, 2000, pp 253-255.

Cations useful as the cationic portion of the ionic photoacid generators include organic onium cations, for example those described in U.S. Pat. Nos. 4,250,311, 3,708,296, 4,069,055, 4,216,288, 5,084,586, 5,124,417, 5,554,664 and such descriptions incorporated herein by reference, including aliphatic or aromatic Group IVA-VIIA (CAS version) centered onium salts, preferably I-, S-, P-, Se- N- and C-centered onium salts, such as those selected from, sulfoxonium, iodonium, sulfonium, selenonium, pyridinium, carbonium and phosphonium, and most preferably I-, and S-centered onium salts, such as those selected from sulfoxonium, diaryliodonium, triarylsulfonium, diarylalkylsulfonium, dialkylarylsulfonium, and trialkylsulfonium wherein “aryl” and “alkyl” are as defined and having up to four independently selected substituents. The substituents on the aryl or alkyl moieties will preferably have less than 30 carbon atoms and up to 10 heteroatoms selected from N, S, non-peroxidic O, P, As, Si, Sn, B, Ge, Te, Se. Examples include hydrocarbyl groups such as methyl, ethyl, butyl, dodecyl, tetracosanyl, benzyl, allyl, benzylidene, ethenyl and ethynyl; hydrocarbyloxy groups such as methoxy, butoxy and phenoxy; hydrocarbylmercapto groups such as methylmercapto and phenylmercapto; hydrocarbyloxycarbonyl groups such as methoxycarbonyl and phenoxycarbonyl; hydrocarbylcarbonyl groups such as formyl, acetyl and benzoyl; hydrocarbylcarbonyloxy groups such as acetoxy and cyclohexanecarbonyloxy; hydrocarbylcarbonamido groups such as acetamido and benzamido; azo; boryl; halo groups such as chloro, bromo, iodo and fluoro; hydroxy; oxo; diphenylarsino; diphenylstilbino; trimethylgermano; trimethylsiloxy; and aromatic groups such as cyclopentadienyl, phenyl, tolyl, naphthyl, and indenyl. With the sulfonium salts, it is possible for the substituent to be further substituted with a dialkyl- or diarylsulfonium cation; an example of this would be 1,4-phenylene bis(diphenylsufonium).

Useful onium salts photoacid generator include diazonium salts, such as aryl diazonium salts; halonium salts, such as diarlyiodonium salts; sulfonium salts, such as triarylsulfonium salts, such as triphenyl sulfonium triflate; selenonium salts, such as triarylselenonium salts; sulfoxonium salts, such as triarylsulfoxonium salts; and other miscellaneous classes of onium salts such as triaryl phosphonium and arsonium salts, and pyrylium and thiopyrylium salts.

Ionic photoacid generators include, for example, triaryl-sulfonium hexafluoroantimonate, 50 wt % in propylene carbonate available under the trade designation CPI 6976 from Aceto Corporation, Port Washington, NY, USA and quaternary ammonium blocked super acid catalyst, diluted to 50 wt % in propylene carbonate available under the trade designation CXC-1612 from King Industries, Norwalk, CT, USA.

Photosensitizers or photoaccelerator may optionally be used with the photoacid generators. Use of photosensitizers or photoaccelerators alters the wavelength sensitivity of radiation-sensitive compositions employing the latent catalysts and photoacid generators of this invention. This is particularly advantageous when the photoacid generator does not strongly absorb the incident radiation. Use of photosensitizers or photoaccelerators increases the radiation sensitivity, allowing shorter exposure times and/or use of less powerful sources of radiation.

When a thermal acid generator (TAG) is included in the composition, the time and temperature of heat-activated cleavage of the cleavable crosslinking monomer can be reduced. Further, the production of the thermally-generated acid can be controlled by the chemical structure of the TAG.

Upon exposure to thermal energy, TAGs undergo a fragmentation reaction and release one or more molecules of Lewis or Bronsted acid. Useful TAGs are thermally stable up to the activation temperature. Preferred TAGs are those in which the incipient acid has a pKₐ value of less than or equal to 0. Useful thermal acid generators have an activation temperature of 150° C. or less, preferably 140° C. or less. As used herein, “activation temperature” is that temperature at which the thermal release of the incipient acid by the TAG in the adhesive formulation occurs. Typically the TAG will have an activation temperature in a range from about 50° C. to about 150° C.

Useful classes of TAGs can include, for example, alkylammonium salts of sulfonic acids, such as triethylammonium p-toluenesulfonate (TEAPTS). Another suitable class of TAGs is that disclosed in U.S. Pat. No. 6,627,384 (Kim, et al.), the disclosure of which is incorporated herein by reference, which describes cyclic alcohols with adjacent sulfonate leaving groups, such as any of the compounds of the Formulas 1 to 4:

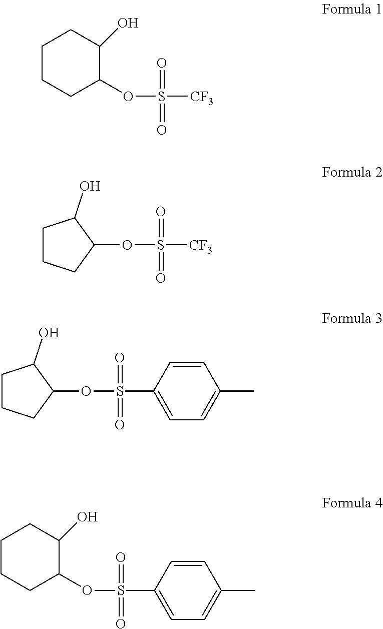 [SMILES: O=S(=O)(OC1CCCCC1O)C(F)(F)F ; O=S(=O)(OC1CCCC1O)C(F)(F)F ; Cc1ccc(S(=O)(=O)OC2CCCC2O)cc1 ; Cc1ccc(S(=O)(=O)OC2CCCCC2O)cc1]

The sulfonate leaving groups in compounds of Formulas 1 to 4 form acids upon the application of heat as is demonstrated in the mechanism shown below.

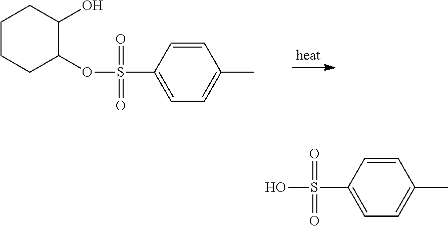 [SMILES: Cc1ccc(S(=O)(=O)OC2CCCCC2O)cc1 ; Cc1ccc(S(=O)(=O)O)cc1]

Suitable classes of thermal acid generators also include those described in U.S. Pat. No. 7,514,202 (Ohsawa et al.) and 5,976,690 (Williams et al.), the disclosures of which are incorporated herein by reference.

The (e.g. adhesive) composition typically comprises one or more acid components that are preferably photoacid generators or thermal acid generators in an amount of at least 0.05 or 0.1 wt. % ranging up to 2, 3, 4, 5, 6, 7, 8, 9, or 10 wt. % of the total (e.g. unfilled) adhesive composition.

### Free Radical Initiators

Useful initiators include those that, on exposure to heat or light, generate free-radicals that initiate (co)polymerization of the monomer mixture. The polymers have pendent unsaturated groups that can be crosslinked by a variety of methods. These include addition of thermal or photoinitiators followed by heat or UV exposure after coating. The polymers may also be crosslinked by exposure to electron beam or gamma irradiation.

Suitable initiators include but are not limited to those selected from the group consisting of azo compounds such as VAZO 64 (2,2′-azobis(isobutyronitrile)), VAZO 52 (2,2′-azobis(2,4-dimethylpentanenitrile)), and VAZO 67 (2,2′-azobis-(2-methylbutyronitrile)) available from E.I. du Pont de Nemours Co., peroxides such as benzoyl peroxide and lauroyl peroxide, and mixtures thereof. The preferred oil-soluble thermal initiator is (2,2′-azobis-(2-methylbutyronitrile)).

Thus the (meth)acrylic polymer can be crosslinked by exposure to heat and/or or actinic (e.g. UV) radiation. The (meth)acrylic polymer can also be cleaved into fragments, by exposure to heat and/or actinic (e.g. UV) radiation. However, the exposure conditions for cleavage are generally different (higher temperature and/or lower wavelength bandwidth) than the exposure conditions for polymerization.

In some embodiments, the cleavable crosslinking monomer is added to the monomer(s) utilized to form the (meth)acrylic polymer. Alternatively or in addition thereto, the cleavable crosslinking monomer may be added to the syrup after the (meth)acrylic polymer has been formed. The (meth)acrylate group of the crosslinker and other (e.g. (meth)acrylate) monomers utilized to form the (meth)acrylic polymer preferentially polymerize forming an acrylic backbone with the cleavable group.

Useful photoinitiators include benzoin ethers such as benzoin methyl ether and benzoin isopropyl ether; substituted acetophenones such as 2,2-dimethoxy-2-phenylacetophenone photoinitiator, available the trade name IRGACURE 651 or ESACURE KB-1 photoinitiator (Sartomer Co., West Chester, PA), and dimethylhydroxyacetophenone; substituted a-ketols such as 2-methyl-2-hydroxy propiophenone; aromatic sulfonyl chlorides such as 2-naphthalene-sulfonyl chloride; and photoactive oximes such as 1-phenyl-1,2-propanedione-2-(O-ethoxy-carbonyl)oxime. Particularly preferred among these are the substituted acetophenones.

Preferred photoinitiators are photoactive compounds that undergo a Norrish I cleavage to generate free radicals that can initiate by addition to the acrylic double bonds. The photoinitiator can be added to the mixture to be coated after the polymer has been formed, i.e., photoinitiator can be added to the syrup composition. Such polymerizable photoinitiators are described, for example, in U.S. Pat. Nos. 5,902,836 and 5,506,279 (Gaddam et al.).

The (e.g. adhesive) composition typically comprises one or more free radical (thermal and/or photo)initiators in an amount of at least 0.05 or 0.1 wt. % ranging up to 2, 3, 4, or 5 wt. % of the total (e.g. unfilled) adhesive composition.

In some embodiments, it is preferable to select a photoinitiator and photoacid generator combination wherein the PAG exhibits little to no UV absorption when a higher wavelength UV irradiation (e.g., UVA radiation, having a wavelength of 400 nm to 315 nm) is used to activate the photoinitiator and polymerize the monomer components, such that activation of the PAG and the cleavable crosslinkers is minimized or nonexistent during this polymerization step. Upon subsequent irradiation of the polymerized material with lower wavelength, high intensity UV irradiation (e.g., UVC radiation, having a wavelength of 280 nm to 100 nm), the PAG may be activated, and cleavable crosslinkers in the polymerized network may be cleaved.

### Method of Making Polymeric Films or Adhesive Articles

The compositions described herein can be utilized to make polymeric films and adhesive articles. In some embodiments, the composition is applied to a substrate such as a release liner or other substrate prior to activation of the cleavable crosslinker by heating and/or exposure to actinic radiation. When the substrate is a release liner, a polymeric film can be formed. When the composition bonds to the substrate, an adhesive (e.g. tape of film) article can be formed

The uncured or partially cured adhesive composition may be coated on and permanently bonded to a substrate to form an adhesive article. The substrate can be flexible or inflexible and can comprise a polymeric organic material, an inorganic material (glass, ceramic material, or metal), or a combination thereof. Some substrates are polymeric films such as those comprising polyolefins (e.g., polyethylene, polypropylene, or copolymers thereof), polyurethanes, polyvinyl acetates, polyvinyl chlorides, polyesters (polyethylene terephthalate or polyethylene naphthalate), polycarbonates, polymethyl(meth)acrylates (PMMA), ethylene-vinyl acetate copolymers, and cellulosic materials (e.g., cellulose acetate, cellulose triacetate, and ethyl cellulose).

Other substrates are metal foils, nonwoven materials (e.g., paper, cloth, nonwoven scrims), foams (e.g., polyacrylic, polyethylene, polyurethane, neoprene), and the like. For some substrates, it may be desirable to treat the surface to improve adhesion to the crosslinked composition, crosslinked composition, or both. Such treatments include, for example, application of primer layers, surface modification layer (e.g., corona treatment or surface abrasion), or both.

In other embodiments, the substrate is a release liner. Release liners typically have low affinity for the curable composition. Exemplary release liners can be prepared from paper (e.g., Kraft paper) or other types of polymeric material. Some release liners are coated with an outer layer of a release agent such as a silicone-containing material or a fluorocarbon-containing material.

In one embodiment, the method comprises providing the composition as described herein; and exposing the composition to a first type of actinic radiation sufficient to activate the photoinitiator, thereby free-radically polymerizing the free-radically polymerizable groups of the composition, obtaining a first polymeric film comprising cleavable crosslinks.

Another embodied method comprises providing the first polymeric film and exposing the first polymeric film to a second type of actinic radiation sufficient to activate the photoacid generator, thereby obtaining a second polymeric film. In this embodiment, the second polymer film comprises uncured epoxy resin moieties and at least a portion of the cleavable crosslinks are cleaved. This method typically further comprises allowing the second polymeric film to further polymerize, thereby obtaining a third polymeric film, wherein the epoxy resin is substantially cured and at least a portion of the cleavable crosslinks are cleaved.

Another embodied method comprises providing the first polymeric film and heating the first polymeric film to activate the thermal acid generator, thereby obtaining a second polymeric film. In this embodiment, the second polymer film comprises uncured epoxy resin moieties and at least a portion of the cleavable crosslinks are cleaved. This method also typically further comprises allowing the second polymeric film to further polymerize, thereby obtaining a third polymeric film, wherein the epoxy resin is substantially cured and at least a portion of the cleavable crosslinks are cleaved.

In another embodiments, a method of bonding is described comprising disposing the first or second polymeric film between a first substrate and a second substrate; exposing the first polymeric film to a second type of actinic radiation sufficient to activate the photoacid generator either before or after disposing the first polymeric film on a first substrate, thereby obtaining a second polymeric film disposed on a first substrate. Alternatively, the method may comprise heating the first polymeric film to activate a thermal acid generator either before or after disposing the first polymer film on a substrate. Both embodiments typically comprise allowing the second polymeric film to further polymerize, thereby obtaining an article comprising a third polymeric film disposed between the first substrate and the second substrate.

In both the method of making a polymeric film and the method of bonding, a combination of photoacid and thermal acid generators may be used. Thus, a combination of exposure to actinic radiation and heating can be utilized to activate the cleavable crosslinker.

### Adhesive Properties & Articles

The composition, comprising polymerized units derived from the described cleavable crosslinking monomer, is generally stable until activation, meaning that the cleavable crosslinking monomer remains essentially crosslinked and unfragmented until activation. The shelf life of the composition at typical storage conditions, ranging from room temperature to 120° F. (25° C. to 49° C.) and 50% relative humidity, is generally sufficient to permit the intended use of the composition. The shelf life is typically at least about one month, about six months, or about one year.

Activation of the cleavable crosslinker occurs by application of an external energy source such as heat, (e.g. ultraviolet) actinic radiation, or a combination thereof.

Once activated, the cleavable crosslinker cleaves forming fragments. The fragment comprises the reaction product of a free-radically polymerizable (e.g. (meth)acrylate)) group bonded to a (e.g. (meth)acrylic polymer) chain and a pendent hydroxyl group. The fragments that form during activation of the cleavable monomer lack free radicals and can also lack ethylenic unsaturation. Thus, the fragments lack functionality to react with each other. Further, the fragments lack functionality to react with any other polymerized units of the (meth)acrylic polymer or any other components present in the composition. Therefore, compositions containing the fragments of the cleavable crosslinker (i.e. cleaved crosslinker) are relatively stable. Further, the sum of the molecular weights of the total fragments is essentially the same as the molecular weight of the composition prior to fragmentation.

In some embodiments, the composition is a pressure sensitive adhesive prior to and after activation of the cleavable crosslinking monomer. In this embodiment, the storage modulus (G′) of the pressure sensitive adhesive at the application temperature, typically room temperature (e.g. 25° C.), is less than 3×10⁵ Pa at a frequency of 1 Hz as obtained utilizing dynamic mechanical analysis according to the test method described in the examples.

In another embodiment, the composition is not a pressure sensitive adhesive prior to activation of the cleavable crosslinking monomer; yet the composition is a pressure sensitive adhesive after activation of the cleavable crosslinking monomer. In this embodiment, the storage modulus of the pressure sensitive adhesive at the application temperature (e.g. 25° C.) is greater than or equal to 3×10⁵ Pa at a frequency of 1 hertz (Hz) prior to cleavage of the cleavable crosslinking monomer; yet less than 3×10⁵ Pa at a frequency of 1 Hz at the application temperature, (e.g. 25° C.) after cleavage of the crosslinking monomer.

In yet other embodiments, the composition is a semi-structural or structural adhesive. In this embodiment, the composition is typically initially a pressure sensitive adhesive. However, after curing of the adhesive composition the storage modulus at ambient temperature (e.g. 25° C.) is typically greater than 3×10⁵ Pa at 1 Hz.

Upon cleavage of at least a portion of the polymerized monomeric units derived from the cleavable crosslinking monomer, the composition exhibits a change in at least one physical property such as gel content, storage modulus, adhesive properties such as peel adhesion, as well as tensile properties such as peak force at break and strain at break, some of which are described in U.S. Pat. No. 9,732,173, incorporated herein by reference.

Also described are adhesive articles comprising a substrate and a polymeric film of the free-radically polymerized composition described herein. The composition may comprise an epoxy resin, an acrylic resin, or a combination thereof as previously described. In some embodiments, the substrate is a release liner, such as in the case of a transfer tape. The polymeric film (e.g. of the transfer tape) may be utilized to permanently bond a first and (e,g, same or different) second substrate.

In one embodiment, the polymeric film comprises the free-radically polymerized product of a (e.g. (meth)acrylic polymer) composition, as described herein. In some embodiments, the composition further comprises uncured epoxy resin moieties and uncleaved cleavable crosslinker. Since the cleavable crosslinker is not activated, the cleavable crosslinker is uncleaved. With reference to Tables 4 and 5, in this embodiment, the polymeric film may exhibit a storage modulus (G′) of greater than 8 kPa (e.g. at time=115 seconds). When the G′ is less than 8 kPa the adhesive can be too soft to easily process. In some embodiments, the CSR at 60 seconds ranges from 60-90 which is indicative of good wet-out for adhesion. In some embodiments, the debond area is less than 20 g·mm since higher values can be difficult to process.

In another embodiment, the composition further comprises uncured epoxy resin moieties and cleaved cleavable crosslinks fragments. With reference to Table 5, in this embodiment, the cleavage of the crosslinks can provide a significant increase in compression strength relaxation ratio (CSR) values and debond area relative to the same polymeric film with uncleaved crosslinker.

With reference to Table 6, in this embodiment, the cleavage of the crosslinks can also provide an decrease in storage modulus (G′) from 115 second to 200 seconds and/or an increase in tan(delta) from 115 second to 200 seconds. In some embodiments, the decrease in G′ is at least 1, 2, 3, 4, 5, 6, 7, 8, 9, or 10 kPa. In some embodiments, the decrease in G′ is no greater than 100, 90, 80, 70, or 60 kPa. In other embodiments, the decrease is not greater than 50, 40, 30, 20, or 10 kPa. In some embodiments, the increase in tan delta is at least 10, 15, 20, or 25% ranging up to 50, 60, 70, 80 or 90%.

With reference to Table 6, upon curing of the epoxy resin the polymeric film can exhibit a greater G′ (e.g. at least 2, 3, 4, 5, 6, 7, 8, 9, or 10 times greater) than the G′ of the same polymeric film wherein the epoxy is uncured. With reference to Table 7, the compositions having an overlap shear value of greater than 200, 300, 400, or 500 psi are useful for semi-structural adhesives; whereas the composition having an overlap shear of greater than 1000 are useful for structural adhesives.

The physical properties of the polymeric film layer can be determined by the test method described in the examples.

The adhesive compositions described herein can be utilized to bond a variety of substrates.

### EXAMPLES

Unless otherwise noted, all parts, percentages, ratios, etc. in the Examples and the rest of the specification are by weight. Unless otherwise indicated, all other reagents were obtained, or are available from fine chemical vendors such as MilliporeSigma (Burlington, MA, USA) or may be synthesized by known methods. Table 1 (below) lists materials used in the examples and their sources.

TABLE 1
Materials List

| | | |
|---|---|---|
| DESIGNATION | DESCRIPTION | SOURCE |

Monofunctional Acrylic Monomers

| | | |
|---|---|---|
| THFA | Tetrahydrofurfuryl acrylate | San Esters [New York, NY, USA] |
| BA | Butyl acrylate | BASF [Ludwigshafen, Germany] |
| E3A | 2-(2-Ethoxyethoxy)ethyl Acrylate | TCI [Tokyo, Japan] |
| TBCHA | t-butyl cyclohexyl acrylate | Miwon North America |
| | | [Exton, PA, USA] |
| IBOA | isobornyl acrylate | San Esters |
| IOA | isooctyl acrylate | MilliporeSigma [Burlington, MA, |
| | | USA] |
| HBA | 4-hydroxybutyl acrylate | TCI America [Portland, OR, USA] |
| HEA | Hydroxyethyl acrylate | TCI America |
| GMA | Glycidyl methacrylate | Dow Chemical [Midland, MI, USA] |
| HPPA | 2-Hydroxy-3-phenoxypropyl acrylate | KOWA American |
| | | Corporation [New York, NY, USA] |

Acrylic Crosslinkers

| | | |
|---|---|---|
| HDDA | Hexanediol diacrylate | Allnex USA Inc. |
| | | [Alpharetta GA, USA] |
| DCDA-1 | 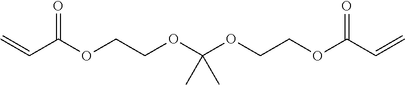 [SMILES: C=CC(=O)OCCOC(C)(C)OCCOC(=O)C=C] | Obtained as described in US10768528 (see “Preparation of Cleavable Diacrylate Crosslinker (CDAC),” Column 23) |
| DCDA-2 | 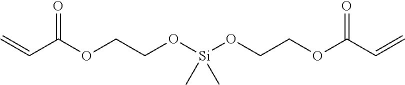 [SMILES: C=CC(=O)OCCO[Si](C)(C)OCCOC(=O)C=C] | Synthesized as described in Preparative Example 1 |
| DCDA-3 | 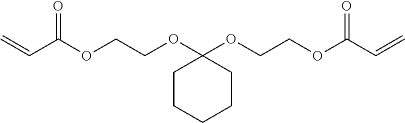 [SMILES: C=CC(=O)OCCOC1(OCCOC(=O)C=C)CCCCC1] | Synthesized as described in Preparative Example 2 |
| DCDA-4 | 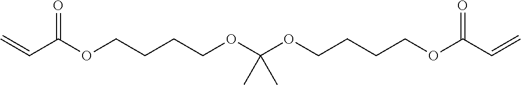 [SMILES: C=CC(=O)OCCCCOC(C)(C)OCCCCOC(=O)C=C] | Synthesized as described in Preparative Example 3 |
| DCDA-5 | 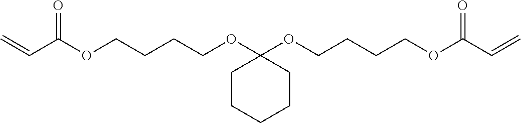 [SMILES: C=CC(=O)OCCCCOC1(OCCCCOC(=O)C=C)CCCCC1] | Synthesized as described in Preparative Example 4 |
| MEHQ | methoxyphenol | BASF |

Epoxy Resin Components

| | | |
|---|---|---|
| EPON 828 | epoxy resin comprised of diglycidyl ether of | Hexion [Columbus, OH, USA] |
| | bisphenol A, obtained under the trade | |
| | designation EPON 828 | |
| EPON 1001F | epoxy resin comprised of diglycidyether of | Hexion |
| | bisphenol A, obtained under the trade | |
| | designation EPON 1001F | |
| HELOXY 68 | epoxy resin comprised of neopentyl glycol | Hexion |
| | diglycidyl ether | |
| ACCLAIM 2200 | Polyether polyol obtained under the trade | Covestro, LLC |
| | designation ACCLAIM 2200 | [Leverkusen, Germany] |

Photoinitiators

| | | |
|---|---|---|
| OM651 | Benzyldimethyl ketal photoinitiator obtained | iGM Resins USA |
| | under the trade designation OMNIRAD 651 | [Charlotte, NC, USA] |
| OM819 | Bis(2,4,6-trimethylbenzoyl)- | iGM Resins USA |
| | phenylphosphineoxide photoinitiator | |
| | obtained under the trade designation | |
| | OMNIRAD819 | |
| CPI 6976 | Triaryl-sulfonium hexafluoroantimonate, 50 | Aceto Corporation [Port |
| | wt % in propylene carbonate obtained under | Washington, NY, USA] |
| | the trade designation CPI6976 | |
| CXC-1612 | Quatemary ammonium blocked super acid | King Industries |
| | catalyst, diluted to 50 wt % in propylene | [Norwalk, CT, USA] |
| | carbonate | |

Formulation Additives

| | | |
|---|---|---|
| Dualite E035-FR | expanded polymer microspheres obtained | Chase Corporation [Westwood, |
| | under the trade designation DUALITE E035- | MA, USA] |
| | FR | |
| GPTMS | 3-(Glycidoxypropyl) trimethoxysilane | Chemical Technologies |
| | | [Levittown, PA, USA] |

Synthetic Reagents

| | | |
|---|---|---|
| DMCH | 1,1-dimethoxycyclohexane | TCI America |
| p-TsOH•H₂O | para-Toluenesulfonic acid monohydrate | MilliporeSigma |

### Test Methods

### Method A: (Rheology, Frequency Sweep and Creep Test)

### Part 1: Frequency Sweep

Uncured tape compositions were analyzed by Dynamic Mechanical Analysis (DMA) using a DHR-3 parallel plate rheometer (TA Instruments, New Castle, DE, USA) fitted with a Peltier plate accessory and 8 mm steel top fixture. The uncured tapes were laminated until a thickness of 0.5-1 mm was achieved. Rheology samples were then punched out with an 8 mm circular die, removed from the release liners, centered on the 8 mm diameter top plate of the rheometer, and the top fixture brought down until the sample was in light contact with the Peltier plate. In some cases, dry ice was used for easier sample loading. The parallel plates were compressed under an axial force control of 50 grams with a sensitivity of +/−25 grams. The sample was conditioned at 25° C. for 120 seconds (s) and then a frequency sweep was run from 0.1 to 100 rad/s at a constant strain of 1 percent.

### Part 2: Creep Test

The axial force was reduced to 0 grams with a sensitivity of +/−15 g. The sample was conditioned at 25° C. for 120 seconds prior to starting the creep test. After such time, a stress of 40 kPa was applied and the strain measured for 30 minutes.

### Method B: UV-Rheology

The uncured tapes were analyzed by Dynamic Mechanical Analysis (DMA) using a DHR-3 parallel plate rheometer (TA Instruments, New Castle, DE, USA) fitted with a 365 nm LED accessory (with 20 mm diameter acrylic plate) and aluminum top fixture of 20 mm diameter. The uncured tapes were laminated until a thickness of 0.5-1 mm was achieved. Rheology samples were then punched out with a 20 mm circular die, removed from the release liner, centered between 20 mm diameter parallel plates of the rheometer, and compressed until the edges of the sample were uniform with the edges of the top and bottom plates. In some cases, dry ice was used for easier handleability of the sample. The parallel plates were compressed under an axial force control of 50 grams with a sensitivity of +/−25 grams. The auto strain adjustment was enabled, and the sample oscillated at a frequency of 1 Hz for 3 minutes. After such time, the 365 nm LED was automatically activated and the sample irradiated for 15 sec at 355 mW/cm², measured UVA with a CON-TROL-CURE SILVER LINE UV Radiometer (TA Instruments), giving the sample a total dose of 5.33 J/cm². The sample was oscillated for an additional 30 min, 60 min, or longer.

### Method C: Probe Tack Test

A TA.XT PLUS TEXTURE ANALYZER (Stable Micro Systems Ltd., UK) with a 5 kg load cell was used for adhesive performance measurements including both the compression stress relaxation ratio and peak force upon probe retraction under ambient conditions. A 6 mm diameter hemispherical stainless steel probe was fixed to the load cell of the texture analyzer. The adhesive was applied to a glass slide and then fixed to the stage of the texture analyzer with exposed adhesive facing upwards to the probe. For each test, the probe was brought into contact with the adhesive using a speed of 0.05 mm/sec until a normal force of 30 g was achieved, allowed to dwell for 65 seconds at that depth, and then retracted at a rate of 0.1 mm/see until the adhesive failed and the normal force was 0 g. During retraction the normal force was plotted as a function of distance. The area under the curve was calculated and reported as the work (gram-force*mm). The compression stress relaxation ratio (CSR) was calculated from the following equation by taking the measured force at 60 sec.

$$\frac{Δ F}{F} = \frac{{F}_{i n i t i a l} - {F}_{final}}{{F}_{i n i t i a l}} \times 1 \; 00 = CSR ( \% )$$

### Method D: Overlap Shear Test Method Sample Preparation

Aluminum substrates measuring 1″×4″×0.064″ (2.5 cm×10.2 cm×0.16 cm) were prepared by scrubbing the terminal 1″ (2.54 cm) with SCOTCH-BRITE GENERAL PURPOSE HAND PAD #7447 (3M) attached to a handheld power sander (RYOBI 2 Amp Corded ¼ Sheet Sander, Hiroshima, Japan) followed by washing with isopropanol and air-drying. A ½″×1″ (1.3 cm×2.5 cm) portion of the uncured tape was applied to the sanded end of one substrate. The release liner was removed from one side of the uncured tape and the tape was applied to one aluminum substrate. The second release liner was removed and the composition was exposed to UV-A radiation using an array of LEDs having a peak emission wavelength of 365 nm (CLEARSTONE TECHNOLOGIES, Hopkins, MN). The total UV-A energy was determined using a POWER PUCK II radiometer (EIT, Inc., Sterling, VA). A second coupon was applied to the irradiated sample, thus closing the bond. The assembly was wet out by means of applying a static load to the specimen for 6 seconds. Specimens were allowed to cure at ambient temperature and humidity for 24 hours prior to testing.

### Method E: Dynamic Overlap Shear Test

A dynamic overlap shear test was performed at ambient temperature using an INSTRON TENSILE TESTER MODEL 5581 (Instron Corp., Canton, MA) equipped with a 10 kN load cell. Test specimens were loaded into the grips and the crosshead was operated at 0.1″ (0.25 cm) per minute, loading the specimen to failure. Stress at break was recorded in units of megapascals and converted to pounds per square inch (psi). Three specimens of each sample were tested, and the average result calculated.

### EXAMPLES

Note: The isolated products for the syntheses of DCDA-2, DCDA-3, DCDA-4, and DCDA-5 (Preparative Examples 1 to 4) were determined to be the structures depicted in the material list based on Nuclear Magnetic Resonance (NMR).

### Preparative Example 1: Synthesis of DCDA-2

Approximately 50 mL of 2-hydroxyethyl acrylate (HEA) was placed over 5 Å molecular sieves. 30 mL (3.33 equiv.) of this HEA was added to a flame-dried 1000-mL round-bottom flask that was backfilled with nitrogen. 200 mL of anhydrous THF was added to the flask as well as 41 mL (3.8 equiv.) of anhydrous triethylamine. The flask was cooled to 0° C. with an ice bath and 9.3 mL (1 equiv.) of dichlorodimethylsilane was added dropwise, and white precipitate formed. The flask was allowed to slowly reach room temperature and then the reaction was heated to 70° C. for 5 hours. The reaction progress was monitored by TLC; it showed at least three spots. The reaction was allowed to stir overnight at room temperature, after which the TLC showed minimal reaction progress. The reaction was filtered through filter paper and the precipitate was washed with THF. The crude material was concentrated under vacuum, redissolved in hexane, and then the leftover hydroxyethyl acrylate was separated using a separatory funnel (bottom layer). The hexane layer was concentrated under vacuum and then purified by flash chromatography (95/5 hexanes/ethyl acetate-->65/35 hexanes/ethyl acetate). The product eluted at approximately 20% ethyl acetate. 15.3 g was isolated (68.5% yield) as a clear oil after sparging to remove residual ethyl acetate.

### Preparative Example 2: Synthesis of DCDA-3

To a three-neck, 100-mL round-bottom flask equipped with a stir bar, stopper, septum, a Dean-Stark trap, and a reflux condenser chilled to 5° C. with a water chiller was added 14.67 g (2.5 equiv.) of hydroxyethyl acrylate (HEA), 7.152 g (1 equiv.) of 1,1-dimethoxycyclohexane, 9.5 mg (0.1 mol % relative to HEA) of p-TsOH·H₂O, 10.6 mg (0.08 mol % relative to HEA) of MEHQ, and 29.27 g of cyclohexane. The mixture was lowered into a 70° C. oil bath and an air sparge was introduced. The reaction was monitored by ¹H-NMR spectroscopy. After 7 hours, the reaction was cooled to ambient temperature and then chromatographed on a 100 g silica column on a Biotage Isolera chromatography system using a 5% to 17% ethyl acetate/hexane solvent gradient over 10 column volumes. The desired product eluted at around 10% ethyl acetate. 13.0331 g was isolated (84% yield).

### Preparative Example 3: Synthesis of DCDA-4

The same method was used as in the synthesis of DCDA-1, except that 4-hydroxybutyl acrylate was used instead of 2-hydroxyethyl acrylate.

### Preparative Example 4: Synthesis of DCDA-5

To a two-neck 100-mL round-bottom flask equipped with a Dean-Stark trap, a reflux condenser, a chiller set to 4° C. and a septum were added 15.15 g (2.2 equiv.) of HBA, 7.09 g (1 equiv.) of 1,1-dimethoxycyclohexane, 9.2 mg (0.1 mol % relative to HBA) of pTsOH·H₂O, 5.2 mg (0.08 mol % relative to HBA) of MEHQ, and 18.29 g of cyclohexane. The mixture was lowered into an oil bath set to 70° C. and a sparge needle with air was introduced subsurface through the septum to help push the MeOH vapor into the Dean-Stark trap. The reaction was heated at 70° for 4.25 hours. After an aliquot was analyzed by ¹H-NMR spectroscopy, the reaction mixture was cooled and then chromatographed on silica using a 5% EtOAc in hexane to 10% EtOAc in hexane gradient. The mixture was concentrated, 9.2 mg of MEHQ was added, and the mixture was sparged with air treated through a drying tube overnight. 10.69 g was isolated (59.8% yield).

### Preparative Example 5: Acrylic Polymer Syrups

Acrylic polymer syrups PE5-A to PE5-E were prepared separately according to the below procedure. A one-liter jar was charged acrylic monomers and photoinitiator in amounts according to Table 2. The given mixture was stirred until the photoinitiator had dissolved and a homogeneous mixture was obtained. The mixture was degassed by introducing nitrogen gas into it through a tube inserted through an opening in the jar's cap and bubbling vigorously for at least 5 minutes. While stirring, the mixture was exposed to UV light until it had a viscosity deemed suitable for coating (˜1000 Pascal-seconds). The light source was an array of LEDs having a peak emission wavelength of 365 nm and an intensity of 0.3 mW/cm². Following UV exposure, air was introduced into the jar.

TABLE 2
Compositions of Acrylic Polymer Syrups

| | | GRAMS | | | | | | | |
|---|---|---|---|---|---|---|---|---|---|
| SYRUP | ACRYLIC MONOMER RATIO | OM651 | BA | THFA | E3A | IBOA | IOA | TBCHA | AA |
| PE5-A | BA/THFA (50/50) | 0.14 | 175 | 175 | | | | | |
| PE5-B | BA/THFA/IBOA (55/20/25) | 0.14 | 192.5 | 70 | | 87.5 | | | |
| PE5-C | BA/E3A/IBOA (35/35/30) | 0.14 | 122.5 | | 122.5 | 105 | | | |
| PE5-D | IOA/THFA/TBCHA (30/45/25) | 0.14 | | 157.5 | | | 105 | 87.5 | |
| PE5-E | IOA/AA (95/5) | 0.14 | | | | | 332.5 | | 17.5 |

### Preparative Example 6: Epoxy-Polyol Blend

Epoxy-polyol blend PE6 was prepared by charging a glass jar with 53.0 parts by weight EPON 828 and 26.5 parts by weight EPON 1001F in the amounts shown and heating the slurry in an oven at 135° C. until a homogenous mixture was obtained. ACCLAIM 2200 (20.5 parts by weight) was added with stirring and the mixture was allowed to cool to ambient temperature. Immediately prior to use, the mixture was re-heated to ca. 93° C. to decrease viscosity for ease of pouring.

### Preparative Example 7: Epoxy Blends

Epoxy blend PE7-A was prepared in the same manner as PE6 except no polyol was added. Epoxy blend PE7-B was prepared by charging a glass jar with 3 parts by weight EPON 828 and 1 part by weight HELOXY 68. The jar was closed tightly with a foil-lined cap and placed on a jar-roller overnight.

### Examples EX1 to EX24 and Comparative Examples CE1 to CE15

### Creation of Adhesive Coating Solutions

The below procedure was carried out separately for each of Examples EX1 to EX24 and Comparative Examples CE1 to CE15. In a glass jar, an acrylic polymer syrup from Preparative Example 5 (Table 2), epoxy-polyol blend PE6, OM819, along with any additional materials were combined in amounts shown in Table 3. For specified examples, fillers and/or interphase crosslinkers (HPPA, GMA) were then added. The jar was closed tightly with a foil-lined cap and placed on a jar-roller overnight protected from light.

### Creation of Uncured Tapes

Uncured tapes were obtained by carrying out the below procedure on each of the adhesive coating formulations from the above step. A layer of the adhesive coating solution was coated between two silicone release-coated PET liners using a two-roll coater having a gap setting of 0.010 inches (254 micrometers) greater than the combined thickness of the two liners. The coated layer was exposed to a total UV-A energy of approximately 3400 mJ/cm² (from two sides with approximately 1700 mJ/cm² per side) using a plurality of LED lamps with a peak emission wavelength of 405 nm. The total UV exposure was determined using a POWER PUCK II radiometer equipped with low power sensing head (EIT, Inc., Sterling, VA).

TABLE 3
Compositions of Examples EX1 to EX24 and Comparative Examples CE1 to CE15

| | Acrylic | | Parts by weight | | | | | |
|---|---|---|---|---|---|---|---|---|
| Example or | Polymer | Degradable | | | | | Acrylic | |
| Comparative | Syrup | Crosslinker | | Degradable | | | Polymer | |
| Example | Identity | Identity | HDDA | Crosslinker | HPPA | GMA | Syrup | CPI6976 |
| CE1 | PE5-A | | 0.05 | | | | 37.7 | 1.5 |
| CE2 | PE5-A | | 0.1 | | | | 37.7 | 1.5 |
| CE3 | PE5-A | | 0.15 | | | | 37.7 | 1.5 |
| CE4 | PE5-A | | 0.5 | | | | 37.7 | 1.5 |
| CE5 | PE5-A | | 1 | | | | 37.7 | 1.5 |
| CE6 | PE5-A | | 2 | | | | 37.7 | 1.5 |
| EX1 | PE5-A | DCDA-1 | 0.05 | 0.5 | | | 37.7 | 1.5 |
| EX2 | PE5-A | DCDA-1 | 0.05 | 1 | | | 37.7 | 1.5 |
| EX3 | PE5-A | DCDA-1 | 0.1 | 0.5 | | | 37.7 | 1.5 |
| EX4 | PE5-A | DCDA-1 | 0.1 | 1 | | | 37.7 | 1.5 |
| EX5 | PE5-A | DCDA-2 | 0.05 | 0.5 | | | 37.7 | 1.5 |
| EX6 | PE5-A | DCDA-2 | 0.05 | 1 | | | 37.7 | 1.5 |
| EX7 | PE5-A | DCDA-3 | 0.05 | 0.5 | | | 37.7 | 1.5 |
| EX8 | PE5-A | DCDA-3 | 0.05 | 1 | | | 37.7 | 1.5 |
| EX9 | PE5-A | DCDA-2 | | 1 | | | 37.7 | 1.5 |
| EX10 | PE5-A | DCDA-3 | | 1 | | | 37.7 | 1.5 |
| CE7 | PE5-B | | 0.2 | | | | 37.7 | 3 |
| EX11 | PE5-A | DCDA-4 | | 1 | | | 37.7 | 3 |
| EX12 | PE5-A | DCDA-5 | | 1 | | | 37.7 | 3 |
| EX13 | PE5-B | DCDA-5 | | 1 | | | 37.7 | 3 |
| CE8 | PE5-C | | 0.2 | | | 2.5 | 37.7 | 3 |
| EX14 | PE5-C | DCDA-3 | 0.05 | 1.3 | | 2.5 | 37.7 | 3 |
| EX15 | PE5-C | DCDA-5 | 0.05 | 1.6 | | 2.5 | 37.7 | 3 |
| CE9 | PE5-D | | 0.2 | | | | 37.7 | 3 |
| EX16 | PE5-D | DCDA-5 | 0.05 | 1.6 | | | 37.7 | 3 |
| CE10 | PE5-B | | 0.2 | | | | 37.7 | 3 |
| EX17 | PE5-B | DCDA-5 | 0.05 | 1.6 | | | 37.7 | 3 |
| EX18 | PE5-C | DCDA-3 | 0.05 | 1 | 4.75 | | 47.5 | 1.5 |
| CE11 | PE5-A | | 0.42 | | | | 100 | 0.5 |
| CE12 | PE5-E | | 0.42 | | | | 100 | 0.5 |
| EX19 | PE5-A | DCDA-5 | | 0.5 | | | 100 | 0.5 |
| EX20 | PE5-E | DCDA-5 | | 0.5 | | | 100 | 0.5 |
| CE13 | PE5-A | | 2.75 | | | | 97.3 | |
| CE14 | PE5-E | | 2.75 | | | | 97.3 | |
| EX21 | PE5-A | DCDA-5 | | 4.5 | | | 95.5 | |
| EX22 | PE5-E | DCDA-5 | | 4.5 | | | 95.5 | |
| CE15 | | | 25 | | | | | 0.83 |
| EX23 | | DCDA-1 | | 25 | | | | 0.83 |
| EX24 | | DCDA-1 | 10 | | | | | 1 |

| | Parts by weight | | | | | | |
|---|---|---|---|---|---|---|---|
| | | | Epoxy- | | | | |
| Example or | | | polyol | Epoxy | Epoxy | | |
| Comparative | | CXC- | blend | Blend | Blend | | Dualite |
| Example | OM819 | 1612 | PE6 | PE7-A | PE7-B | GPTMS | E035-FR |
| CE1 | 0.15 | | 58.8 | | | 1 | |
| CE2 | 0.15 | | 58.8 | | | 1 | |
| CE3 | 0.15 | | 58.8 | | | 1 | |
| CE4 | 0.15 | | 58.8 | | | 1 | |
| CE5 | 0.15 | | 58.8 | | | 1 | |
| CE6 | 0.15 | | 58.8 | | | 1 | |
| EX1 | 0.15 | | 58.8 | | | 1 | |
| EX2 | 0.15 | | 58.8 | | | 1 | |
| EX3 | 0.15 | | 58.8 | | | 1 | |
| EX4 | 0.15 | | 58.8 | | | 1 | |
| EX5 | 0.15 | | 58.4 | | | 1 | |
| EX6 | 0.15 | | 58.4 | | | 1 | |
| EX7 | 0.15 | | 58.4 | | | 1 | |
| EX8 | 0.15 | | 58.4 | | | 1 | |
| EX9 | 0.15 | | 58.4 | | | 1 | |
| EX10 | 0.15 | | 58.4 | | | 1 | |
| CE7 | 0.2 | | 57.8 | | | 1 | |
| EX11 | 0.2 | | 57.8 | | | 1 | |
| EX12 | 0.2 | | 57.8 | | | 1 | |
| EX13 | 0.2 | | 57.8 | | | 1 | |
| CE8 | 0.2 | | 57.8 | | | 1 | |
| EX14 | 0.2 | | 57.8 | | | 1 | |
| EX15 | 0.2 | | 57.8 | | | 1 | |
| CE9 | 0.2 | | 57.8 | | | 1 | |
| EX16 | 0.2 | | 57.8 | | | 1 | |
| CE10 | 0.2 | | 57.8 | | | | |
| EX17 | 0.2 | | 57.8 | | | | 1.2 |
| EX18 | 0.2 | | | 47.5 | | 1 | |
| CE11 | 0.24 | | | | | | |
| CE12 | 0.24 | | | | | | |
| EX19 | 0.24 | | | | | | |
| EX20 | 0.24 | | | | | | |
| CE13 | 0.24 | 0.3 | | | | | |
| CE14 | 0.24 | 0.3 | | | | | |
| EX21 | 0.24 | 0.3 | | | | | |
| EX22 | 0.24 | 0.3 | | | | | |
| CE15 | 0.2 | | 75 | | | 1 | |
| EX23 | 0.2 | | 75 | | | 1 | |
| EX24 | 0.2 | | | | 90 | 1 | |

### Rheology and Probe-Tack Testing of Uncured Tapes

Parallel-plate rheology was used to measure the modulus of the uncured tapes by a frequency sweep test according to METHOD A, Part 1; the storage modulus (G′, kPa) at frequency=1 Hz is reported in Table 4. A creep test (METHOD A, Part 2) was used to measure stability (cold-flow) of the uncured tape and was also to quantify handleability; the strain at 100 seconds is reported in Table 4. Another method of examining handleability is through a probe-tack test to measure the compression stress-relaxation ratio and quantify tack through a pull-out method (METHOD C). There is strong correlation between compression stress-relaxation ratio (CSR) and wet-out; it is often used as a quick measurement to optimize crosslinker loading. Results of the shear rheology and probe-tack tests on several exemplary uncured tapes are shown in Table 4.

TABLE 4
Rheology and probe-tack evaluations of uncured tapes

| | |
|---|---|
| SHEAR | PROBE-TACK |
| RHEOLOGY | TEST |

| Example or | | % | % | Debond |
|---|---|---|---|---|
| Comparative | G′ | Strain | CSR | Area |
| Example | (kPa) | (100 s) | (60 s) | (g · mm) |
| CE1 | 5.2 | 3580 | 97 | ND |
| CE2 | 5.6 | 862 | 87 | 45.8 |
| CE3 | 7.0 | 311 | 69 | 26.7 |
| CE4 | 18.1 | 41 | 28 | 3 |
| CE5 | 34.9 | 11 | 38 | 1.4 |
| CE6 | 84.1 | 10 | 57 | 0.6 |
| EX1 | 12.8 | 67 | 39 | 9.2 |
| EX2 | 22.2 | 25 | 18 | 3.1 |
| EX3 | 13.2 | 45 | 42 | 6 |
| EX4 | 24.4 | 19 | 22 | 2.7 |
| EX5 | 10.9 | 45 | 28 | 2.9 |
| EX6 | 15.4 | 16 | 31 | 0.9 |
| EX7 | 8.5 | 81 | 45 | 4.5 |
| EX8 | 14.8 | 24 | 45 | 0.9 |
| EX9 | 15.6 | 31 | 43 | 0.4 |
| EX10 | 12.3 | 37 | 44 | 0.9 |

Examples 1-10 increase in CSR and Debond Area after activation of the cleavable crosslinker. However, this property is difficult to measure since such property is temporary and changing.

### Probe Tack Evaluation of Uncured and Activated Tapes Containing Thermal Acid Generator

A probe-tack test was used to measure the initial compression stress-relaxation ratio and quantify tack through a pull-out method (METHOD C). The samples were then heated to 100° C. for 20 min and the probe-tack test was repeated. The results are shown in Table 5. The final CSR and tack (debond) can be modified by adjusting the amount of degradable crosslinker or adding non-degradable crosslinkers to the composition.

TABLE 5
Probe tack evaluation of tapes with thermal acid generator.

| | | | INITIAL | | POST HEAT | |
|---|---|---|---|---|---|---|
| Example or | | | | Debond | % | Debond |
| Comparative | WT % CROSSLINKER | | % CSR | Area | CSR | Area |
| Example | HDDA | DCDA-5 | (60 s) | (g · mm) | (60 s) | (g · mm) |
| CE13 | 2.75 | | 27 | 0.30 | 22 | 0.55 |
| EX21 | | 4.50 | 22 | 0.13 | 84 | 7.89 |
| CE14 | 2.75 | | 9 | 0.58 | 8 | 1.07 |
| EX22 | | 4.50 | 9 | 0.52 | 91 | 51.09 |

### UV Rheology Testing of Tapes

UV rheology was used to evaluate the modulus and tan(delta) of the tapes before, during, and post-UV activation (throughout the transition from uncured tape through activated tape to cured tape) using a time-sweep method (METHOD B). The modulus of the material was monitored for 3 min before the 365 nm LED was applied (irradiation duration of 15 s for a total of 5 J/cm²). The initial (t=115 s) tan(delta) and the tan(delta) immediately after UV-activation (t=200 s) was reported in order to accurately compare HDDA samples to DCDA samples. A percent change ratio between the pre-UV tan(delta) and post-UV tan(delta) can then be calculated to characterize the breakdown of the acrylic network. The results of the UV-rheology studies are shown in Table 6.

TABLE 6
Results of UV rheology testing

| | | | | | | % change |
|---|---|---|---|---|---|---|
| Example or | G′ (kPa) | | | | | from |
| Comparative | initial | | | tan(delta) | | t = 115 s |
| Example | (t = 115 s) | t = 200 | t = 1800 s | t = 115 s | t = 200 s | to 200 s |
| CE1 | 5.09 | 5.00 | 195 | 1.1 | 1.09 | −1 |
| CE2 | 5.60 | 5.40 | 215 | 0.93 | 0.91 | −2 |
| CE3 | 6.94 | 7.00 | 227 | 0.79 | 0.77 | −3 |
| CE4 | 18.21 | 21.10 | 135 | 0.28 | 0.26 | −6 |
| CE5 | 35.63 | 37.30 | 214 | 0.10 | 0.09 | −14 |
| CE6 | 84.31 | 86.90 | 242 | 0.08 | 0.08 | −6 |
| EX1 | 12.53 | 8.80 | 126 | 0.49 | 0.75 | 35 |
| EX2 | 21.87 | 12.90 | 135 | 0.28 | 0.56 | 50 |
| EX3 | 13.22 | 6.90 | 221 | 0.41 | 0.78 | 47 |
| EX4 | 24.35 | 8.70 | 258 | 0.21 | 0.63 | 67 |
| EX5 | 10.80 | 6.70 | 625 | 0.34 | 0.56 | 40 |
| EX6 | 15.50 | 9.30 | 528 | 0.14 | 0.27 | 49 |
| EX7 | 8.46 | 7.20 | 419 | 0.49 | 0.65 | 25 |
| EX8 | 15.20 | 12.00 | 576 | 0.19 | 0.26 | 25 |
| EX9 | 15.80 | 10.90 | 284 | 0.21 | 0.32 | 35 |
| EX10 | 12.40 | 10.50 | 356 | 0.26 | 0.30 | 15 |
| EX11 | 11.70 | 2.71 | 1370 | 0.35 | 1.34 | 74 |
| EX12 | 21.80 | 2.97 | NT | 0.17 | 1.31 | 87 |
| CE7 | 2.75 | 2.90 | 1680 | 0.99 | 0.98 | −1 |
| EX13 | 8.64 | 1.64 | 7630 | 0.57 | 2.07 | 72 |
| CE8 | 3.58 | 3.74 | 455 | 0.85 | 0.80 | −6 |
| EX14 | 12.15 | 7.63 | 497 | 0.18 | 0.35 | 47 |
| EX15 | 13.14 | 2.17 | 642 | 0.20 | 1.38 | 85 |
| CE9 | 3.00 | 3.02 | 1222 | 0.86 | 0.80 | −8 |
| EX16 | 9.23 | 3.96 | 13120 | 0.39 | 0.51 | 23 |
| CE10 | 8.55 | 8.45 | 702.4 | 1.04 | 1.02 | −2 |
| EX17 | 60.88 | 6.64 | 4244 | 0.13 | 1.17 | 89 |
| EX18 | 22.32 | 15.13 | 486 | 0.49 | 0.85 | 42 |
| CE11 | 44.98 | 45.44 | NA | 0.29 | 0.30 | 1 |
| CE12 | 7.74 | 7.78 | NA | 0.40 | 0.40 | 1 |
| EX19 | 14.87 | 13.15 | NA | 0.43 | 0.70 | 39 |
| EX20 | 24.71 | 19.48 | NA | 0.43 | 0.69 | 37 |

NA = Not Applicable;
NT = Not tested

### Overlap Shear Testing of Cured Tapes

Overlap shear testing was used to evaluate the performance of the cured tapes. The samples were prepared according to METHOD D and tested according to METHOD E. The results are shown in Table 7.

TABLE 7
Overlap shear testing on cured tapes

| Example or | Acrylic | wet-out | | | Peak | Std | Peak | Std | |
|---|---|---|---|---|---|---|---|---|---|
| Comparative | Polymer | force | Irrad. | Dose | Stress | Dev | Stress | Dev | Failure |
| Example | syrup | (lbf) | (W/cm²) | (J/cm²) | (psi) | (psi) | (kPa) | (kPa) | Mode |
| CE1 | PE5-A | 15 | 1.18 | 7.8 | 999 | 151 | 6887 | 1043 | ma |
| CE2 | PE5-A | 15 | 1.18 | 7.8 | 1245 | 81 | 8584 | 559 | adh |
| CE3 | PE5-A | 15 | 1.18 | 7.8 | 1149 | 33 | 7922 | 226 | adh |
| CE4 | PE5-A | 15 | 1.18 | 7.8 | 1051 | 31 | 7246 | 214 | ma |
| CE5 | PE5-A | 15 | 1.18 | 7.8 | 805 | 77 | 5550 | 534 | adh |
| CE6 | PE5-A | 15 | 1.18 | 7.8 | 519 | 122 | 3578 | 843 | ma |
| EX1 | PE5-A | 15 | 1.18 | 7.8 | 1099 | 41 | 7577 | 279 | ma |
| EX2 | PE5-A | 15 | 1.18 | 7.8 | 1200 | 139 | 8274 | 958 | ma |
| EX3 | PE5-A | 15 | 1.18 | 7.8 | 1235 | 106 | 8515 | 731 | ma |
| EX4 | PE5-A | 15 | 1.18 | 7.8 | 954 | 155 | 6578 | 1068 | adh |
| EX5 | PE5-A | 15 | 1.18 | 7.8 | 986 | 167 | 6798 | 1153 | adh |
| EX6 | PE5-A | 15 | 1.18 | 7.8 | 827 | 195 | 5702 | 1345 | adh |
| EX7 | PE5-A | 15 | 1.18 | 7.8 | 1044 | 87 | 7198 | 600 | ma |
| EX8 | PE5-A | 15 | 1.18 | 7.8 | 1001 | 167 | 6902 | 1153 | ma |
| EX9 | PE5-A | 1 | 1.18 | 7.8 | 725 | 91 | 4999 | 624 | adh |
| EX10 | PE5-A | 1 | 1.18 | 7.8 | 952 | 97 | 6564 | 666 | adh |
| EX11 | PE5-A | 40 | 0.83 | 5.4 | 1195 | 132 | 8239 | 910 | adh |
| EX12 | PE5-A | 0 | 0.83 | 5.4 | 884 | 177 | 6095 | 1220 | ma |
| CE7 | PE5-B | 40 | 0.83 | 5.4 | 595 | 78 | 4102 | 538 | adh |
| EX13 | PE5-B | 0 | 0.83 | 5.4 | 816 | 27 | 5626 | 186 | adh |
| CE8 | PE5-C | 30 | 0.83 | 5.4 | 924 | 147 | 6371 | 1014 | adh |
| EX14 | PE5-C | 30 | 0.83 | 5.4 | 1191 | 167 | 8212 | 1151 | adh |
| EX15 | PE5-C | 30 | 0.83 | 5.4 | 1342 | 46 | 9253 | 317 | adh |
| CE9 | PE5-D | 30 | 0.83 | 5.4 | 1795 | 142 | 12376 | 979 | adh |
| EX16 | PE5-D | 30 | 0.83 | 5.4 | 1888 | 333 | 13017 | 2296 | adh |
| CE10 | PE5-B | 30 | 0.83 | 5.4 | 803 | 72 | 5537 | 494 | coh |
| EX17 | PE5-B | 30 | 0.83 | 5.4 | 986 | 124 | 6798 | 855 | coh |
| EX18 | PE5-C | 30 | 0.83 | 5.4 | 505 | 162 | 3480 | 1119 | adh |
| CE15 | | 30 | 0.83 | 5.4 | 233 | 139 | 1609 | 959 | adh |
| EX23 | | 30 | 0.83 | 5.4 | 460 | 241 | 3174 | 1660 | adh |
| EX24 | | 30 | 0.83 | 5.4 | 352 | 221 | 2425 | 1524 | adh |

All cited references, patents, and patent applications in the above application for letters patent are herein incorporated by reference in their entirety in a consistent manner. In the event of inconsistencies or contradictions between portions of the incorporated references and this application, the information in the preceding description shall control. The preceding description, given in order to enable one of ordinary skill in the art to practice the claimed disclosure, is not to be construed as limiting the scope of the disclosure, which is defined by the claims and all equivalents thereto.

1. A composition comprising:
a) an epoxy resin; and
b) a cleavable crosslinker comprising at least two free-radically polymerizable groups, with the proviso that the cleavable crosslinker does not contain a nitrogen-nitrogen bond.

2. The composition of claim 1, wherein the composition further comprises at least one other free-radically polymerizable monomer, oligomer, polymer, or combination thereof.

3. The composition of claim 2, wherein b) and/or other free-radically polymerizable monomer, oligomer, polymer, or combination thereof comprises one or more (meth)acrylate groups.

4. The composition of claim 1 further comprising an acid component (e.g. photoacid generator, thermal acid generator), a free-radical initiator, or a combination thereof.

5. The composition of claim 2 wherein the other free-radically polymerizable component comprises a (meth)acrylic polymer, a non-cleavable crosslinker, or combination thereof.

6. The composition of claim 1 wherein the composition further comprises a hydroxy-containing component.

7. The composition of claim 5 wherein the hydroxy-containing component comprises a polyol.

8. The composition of claim 1, wherein the cleavable crosslinker comprises a group having the formula —O—X(R2)(R3)-O—, wherein X is C or Si and R1 and R2 are independently hydrogen alkyl, aryl; or X is C and together with R2 and R3 is a cycloaliphatic group.

9. The composition of claim 1, wherein the cleavable crosslinker has the formula: 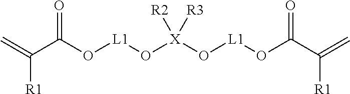
wherein X is C or Si;
R1 is independently hydrogen or methyl;
L1 is independently a divalent linking group; and
R2 and R3 are independently hydrogen, alkyl, aryl, or X is C and together with R2 and R3 is a cycloaliphatic group.

10. A cleavable crosslinker of the formula: 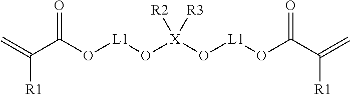
R1 is independently hydrogen or methyl;
L1 is independently a divalent linking group; and
wherein X is C and together with R2 and R3 is a cycloaliphatic group.

11. A composition comprising:
the cleavable crosslinker of claim 10; and
at least one other free-radically polymerizable monomer, oligomer, polymer, or combination thereof.

12. (canceled)

13. The composition of claim 1 wherein the free-radically polymerizable component is polymerized and the composition comprises crosslinks of uncleaved cleavable crosslinker, cleaved cleavable crosslinker fragments, or a combination thereof.

14. A polymeric film comprising the free-radically polymerized product of the composition of claim 1.

15. The polymeric film of claim 14 further comprising uncured epoxy resin moieties and crosslinks derived from uncleaved cleavable crosslinker.

16. The polymeric film of claim 15, wherein the polymeric film exhibits a storage modulus (G′) of greater than 8 kPa at 25° C. and 1 hertz.

17. The polymeric film of claim 14 further comprising uncured epoxy resin moieties and cleaved cleavable crosslinker fragments.

18. The polymeric film of claim 17, wherein the polymeric film has a greater tan(delta) and/or lower storage modulus (G′) than the same polymeric film with uncleaved cleavable crosslinker.

19. The polymeric film of claim 15, wherein upon curing of the epoxy resin the polymeric film exhibits a G′ at least 5 times greater than the same polymeric film with uncured epoxy resin.

20. An adhesive article comprising a substrate and the polymeric film of claim 15 disposed on the substrate.

21-22. (canceled)

23. An adhesive bonded article comprising a first and second substrate bonded with the polymerized composition of claim 1.
